(19) United States
(12) Patent Application Publication
(10) Pub. No.: US 2021/0065739 A1
(43) Pub. Date: Mar. 4, 2021

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Masaru Atsumi, Kawasaki Kanagawa (JP)

(21) Appl. No.: 16/808,596

(22) Filed: Mar. 4, 2020

(30) Foreign Application Priority Data
Aug. 26, 2019 (JP) 2019-153794

(51) Int. Cl. G11B 5/03; G11B 5/012

(52) U.S. Cl. CPC G11B 5/03; G11B 2005/0024; G11B 5/012

(57) ABSTRACT

According to one embodiment, a magnetic disk device includes a magnetic disk, a write head which includes an assist unit configured to assist in writing data to the magnetic disk, a read head configured to read data from the magnetic disk, and a control unit configured to control writing data to the magnetic disk by the write head and reading data from the magnetic disk by the read head. The magnetic disk includes a first region in which reading/writing data is performed by a first processing method and a second region in which reading/writing data is performed by a second processing method different from the first processing method. The control unit is operable to change assist power of the assist unit between the first region and the second region when writing data to the magnetic disk by the write head.

### CROSS-REFERENCE TO RELATED APPLICATIONS

This application is based upon and claims the benefit of priority from Japanese Patent Application No. 2019-153794, filed Aug. 26, 2019, the entire contents of which are incorporated herein by reference.

### FIELD

Embodiments described herein relate generally to a magnetic disk device.

### BACKGROUND

For magnetic disk devices, microwave assisted magnetic recording (MAMR) is considered in which, in order to improve recording density, a high-frequency magnetic field is applied to a recording medium with high magnetic anisotropy, a medium coercive force (Hc) is lowered, and a recording is made. In a recording head used in this method, a spin torque oscillation (STO) element in which a field generation layer (FGL), a spin injection layer (SIL), and the like are laminated is mounted between recording poles to apply a high-frequency magnetic field. In a magnetic disk device having such a configuration, a bias voltage is applied to the STO element to pass electrons from the FLG to the SIL, thereby the spin torque effect is caused to oscillate the FGL, reducing the coercive force of a recording medium. Therefore, record data can be recorded even with a weak recording magnetic field generated by a smaller recording element.

On the other hand, shingled magnetic recording (SMR) is provided as a recent technology for improving recording density. In a conventional magnetic recording (CMR), data tracks are recorded with a spacing therebetween according to a magnetic writer width (MWW) of a recording element, but in the SMR, data tracks are written so as to overlap with each other on one side with a spacing smaller than that according to the MWW. Therefore, high-density recording is enabled while maintaining recording quality. However, since track scanning is limited in one direction in recording, when record data from a host requires random write, the record data is temporarily recorded in a cache area which is provided partially in a medium and can be used for the CMR, and after the record data is shaped in data usable for sequential write, the shingled recording is performed. Thus, the SMR requires a longer time than the CMR to record the record data.

It is considered that, in the future, a magnetic recording device employs microwave assisted magnetic recording and includes both of a region for data recording using the SMR and a region for data recording using the CMR. However, in the microwave assisted magnetic recording, the bias voltage applied to the STO element has an optimum value being different between the CMR and the SMR. Therefore, when the bias voltage is applied to the STO element to be suitable for one of the CMR and the SMR, the bias voltage becomes unsuitable for the other. Such a state also occurs, for example, in a magnetic disk device adopting heat-assisted magnetic recording.

It is an object of the present invention to provide a magnetic disk device which includes a magnetic recording head configured to assist in data recording, and a magnetic disk having thereon a data recording area for a first method and a data recording area for a second method different from the first method and which has a large capacity, high reliability, and high manufacturing yield.

### BRIEF DESCRIPTION OF THE DRAWINGS

FIG. 1 is a diagram illustrating an example of a schematic configuration of a magnetic disk device according to an embodiment.

FIG. 2 is a diagram illustrating an example of a cross-section of a magnetic head according to the embodiment.

FIG. 3 is a diagram illustrating an example of a structure of an STO element according to the embodiment.

FIG. 4 is a diagram illustrating an example of a recording area of a data surface of a magnetic disk according to the embodiment.

FIG. 5 is a flowchart illustrating an example of an optimization method for bias voltage applied to the STO element according to the embodiment.

FIG. 6 is a graph illustrating an example of an amount of improvement of a recording density in a CMR region, according to the embodiment at each STO bias voltage level.

FIG. 7 is a graph illustrating an example of comparison in the amount of improvement of the recording density at each STO bias voltage level between the CMR region and an SMR region, according to the embodiment.

FIG. 8 is a table illustrating an example of setting STO bias voltage values according to an embodiment.

FIG. 9 is a table illustrating an example of setting STO bias voltage values where setting for each zone is added, according to the embodiment.

FIG. 10 is a table illustrating an example of setting STO bias voltage values where a fixed value is set for all zones according to the embodiment.

FIG. 11 is a table illustrating an example of setting STO bias voltage values where a fixed value is set for each zone according to an embodiment.

FIG. 12 is a diagram illustrating an example of a resistance of the STO element and a circuit resistance in a preamplifier according to the embodiment.

FIG. 13 is a flowchart illustrating an example of a process of setting an STO bias voltage according to the embodiment.

FIG. 14 is a table illustrating an example of setting STO bias voltage values according to the embodiment.

FIG. 15 is a diagram illustrating an example of a cross-section of a schematic configuration of a magnetic head according to a modification of the embodiment.

### DETAILED DESCRIPTION

In general, according to one embodiment, a magnetic disk device includes a magnetic disk, a write head which includes an assist unit configured to assist in writing data to the magnetic disk, a read head configured to read data from the magnetic disk, and a control unit configured to control writing data to the magnetic disk by the write head and reading data from the magnetic disk by the read head. The magnetic disk includes a first region in which reading/writing data is performed by a first processing method and a second region in which reading/writing data is performed by a second processing method different from the first processing method. The control unit is operable to change assist power of the assist unit between the first region and the second region when writing data to the magnetic disk by the write head.

Hereinafter, embodiments will be described with reference to the drawings. Note that the disclosure is merely an example, and the invention is not limited by the contents described in the following embodiments. Modifications and variations readily conceivable by those skilled in the art are naturally included in the scope of the disclosure. In the drawings, each portion may be schematically illustrated by changing the size, shape, and the like thereof from those in actual embodiments, for clarity of description. In a plurality of drawings, corresponding elements are denoted by the same reference numerals, and a detailed description thereof may be omitted.

### First Embodiment

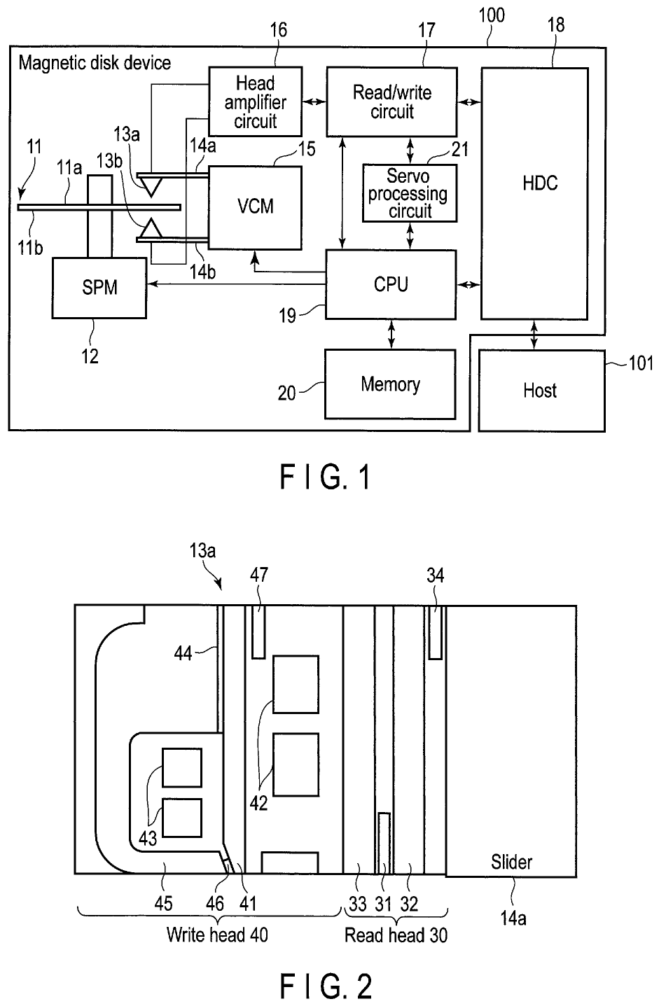

FIG. 1 is a diagram illustrating an example of a schematic configuration of a magnetic disk device 100.

The magnetic disk device 100 includes a magnetic disk 11 configured to write data. The magnetic disk 11 is rotationally driven by a spindle motor (SPM) 12. The magnetic disk 11 has two data surfaces of an upper data surface 11a and a lower data surface 11b. Data is written to each of the data surfaces 11a and 11b. On each of the data surfaces 11a and 11b of the magnetic disk 11, a large number of concentric tracks are formed, and each of the tracks has a servo area in which servo data used for positioning control and the like is written and a data area in which data is written. A reproducing/recording composite heads (hereinafter referred to as “magnetic heads”) 13a or 13b used to write data to the magnetic disk 11 and read data from the magnetic disk 11 are provided for both sides of the magnetic disk 11. The magnetic heads 13a and 13b are respectively mounted on sliders 14a and 14b configured to fly over the rotating magnetic disk 11. The magnetic heads 13a and 13b are each moved in a radial direction of the magnetic disk 11 by a slider movement mechanism (voice coil motor: VCM) 15, seek a target position on the magnetic disk 11, and are positioned at the target position. The VCM 15 is operated based on an instruction from a CPU 19. The magnetic heads 13a and 13b each include a read head and a write head. The read head is an MR head using a magnetoresistive effect element, and the write head uses a magnetic recording head including an assist unit configured to assist in writing data with high-frequency. Note that FIG. 1 illustrates a configuration in which one magnetic disk 11 is provided and the magnetic heads 13a and 13b are provided for both surfaces of the magnetic disk 11, but two or more sets of the magnetic disk 11 and the magnetic heads 13a and 13b may be provided.

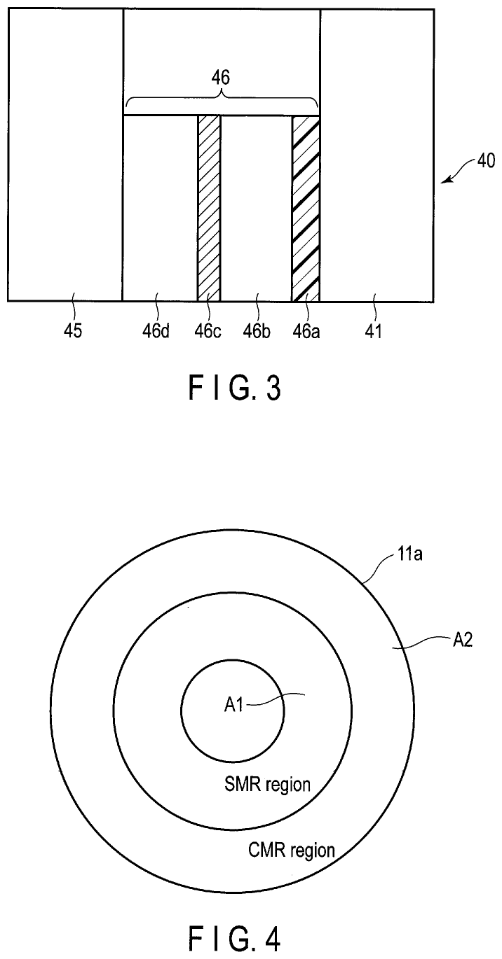

Here, structures of the magnetic heads 13a and 13b will be described with reference to FIGS. 2 and 3. Note that since the magnetic heads 13a and 13b have the same structure, and an example of the magnetic head 13a will be described. FIG. 2 is a diagram illustrating an example of a cross-section of the magnetic head 13a, and FIG. 3 is a diagram illustrating an example of a structure of an STO element.

As illustrated in FIG. 2, the magnetic head 13a includes the read head (reproducing head) 30 on a side of the slider 14a and the write head 40 positioned on a side of the read head 30, opposite to the side on which the slider 14a is positioned. In the read head 30, an MR element 31 as a magnetic sensing portion is disposed in a space defining a predetermined gap between a lower shield core 32 and an upper shield core 33. Furthermore, the write head 40 has an inductive head structure including a main magnetic pole 41, write coils 42 and 43, an insulating layer 44, an auxiliary magnetic pole 45, and an STO element 46.

The write head 40 further includes the STO element 46 between the main magnetic pole 41 and the auxiliary magnetic pole 45, as detailed in FIG. 3. The STO element 46 is configured by laminating a seed layer 46a, a field generation layer (FGL) 46b, a metal spacer 46c, and a spin injection layer (SIL) 46d in a direction from the main magnetic pole 41 side to the auxiliary magnetic pole 45. The FGL 46b is a field generation layer configured to generate a high-frequency magnetic field, and the SIL 46d is a spin injection layer configured to apply a spin torque to the FGL 46b. In order to use both the main magnetic pole 41 and the auxiliary magnetic pole 45 as electrodes for applying current to the STO element 46 therethrough, a rear end portion of the STO element 46 is electrically insulated by the insulating layer 44 and connected to a drive power source of the STO element 46 (not illustrated).

In the magnetic disk device 100, when writing data, a recording current for generating a recording magnetic field is applied to the magnetic poles of the write coils 42 and 43, and in the main magnetic pole 41 and the auxiliary magnetic pole 45, bias voltage is applied to the STO element 46 by an STO drive power source, not illustrated, so that current passes from the SIL 46d to the FGL 46b, thus recording data on the magnetic disk 11. Therefore, change of the bias voltage applied to the STO element 46 enables change of assist power for assisting in data writing. The bias voltage applied to the STO element, namely, STO bias voltage, has a magnitude adjusted and determined by an optimization method for each of a CMR region where processing is performed by a CMR method (first method) and an SMR region where processing is performed by an SMR method (second method). Details of this optimization method will be described later.

The description returns to FIG. 2. The read head 30 includes a read heater 34, and the write head includes a write heater 47. Upon reading or writing, the read heater 34 or the write heater 47 is heated, the heat causes the read head 30 or the write head 40 to locally expand with respect to the data surface 11a of the magnetic disk 11, and the amount of spacing of the data surface 11a is controlled.

Next, a recording area of the magnetic disk 11 will be described. FIG. 4 is a diagram illustrating an example of the recording area of the data surface 11a of the magnetic disk 11. The data surface 11a of the magnetic disk 11 includes the SMR region A1 for performing shingled recording and the CMR region A2 for performing normal recording with a width corresponding to the width of a writing element, and both the regions A1 and A2 secure a defined user capacity. In the present embodiment, the CMR region A2 is provided outside the SMR region A1. Note that the capacity and a recording location (according to medium area/magnetic head) of each area may be changeable by the user within the defined capacity in the SMR region A1/CMR region A2. In the SMR region A1, shingled recording is performed from the outer side to the inner side or from the inner side to the outer side, in each band unit including tens to hundreds of tracks. Since the recording order between the bands is not defined, a guard area is provided between adjacent bands to prevent overwriting.

The description returns to the magnetic disk device 100 of FIG. 1.

The magnetic heads 13a and 13b are connected to a head amplifier circuit 16. The head amplifier circuit 16 manages input/output of a read/write signal between the magnetic heads 13a and 13b. The head amplifier circuit 16 has a reproduction signal amplification function for amplifying a signal from the read head 30, recording amplification section for supplying a recording current to the write head 40 in synchronization with a recording signal from a read/write circuit 17, a flying control function for supplying power to the read heater 34 and write heater 47 and adjusting the flying height of the magnetic heads 13a and 13b, and further an STO drive function for applying bias voltage to the STO element 46, and these functions are achieved according to an instruction from the CPU 19, which is described later. The read/write circuit 17 is connected to the head amplifier circuit 16. The read/write circuit 17 includes a read channel having a decoding function performing signal processing necessary for data reproduction operation, on an input read signal amplified by the head amplifier circuit 16 and sent from the magnetic heads 13a and 13b, and a write channel having record compensation section for encoding record data or adjusting a signal inversion position. The read/write circuit 17 is connected to a hard disk controller (hereinafter referred to as “HDC”) 18 and the CPU 19.

The HDC 18 serves as an interface with a host 101. The HDC 18 controls a command and data communication with the host 101 and also controls data communication with the magnetic disk 11 via the read/write circuit 17 and the head amplifier circuit 16.

The CPU (control unit) 19 serves as a main control device configured to control each unit in the magnetic disk device 100 according to a control program or control parameter stored in a memory 20. The control parameter, for example, an STO bias voltage value is adjusted or set for magnetic heads 13 and zones, in each of the SMR region A1 and the CMR region A2, at a manufacturing stage, and the STO bias voltage values having been adjusted or the like are registered in the form of a matrix table in the memory 20. Details of the matrix table will be described later.

A servo processing circuit 21 is connected to the read/write circuit 17 and the CPU 19. The servo processing circuit 21 performs processing so that the magnetic heads 13a and 13b seek a target position on the magnetic disk 11 and are positioned thereto.

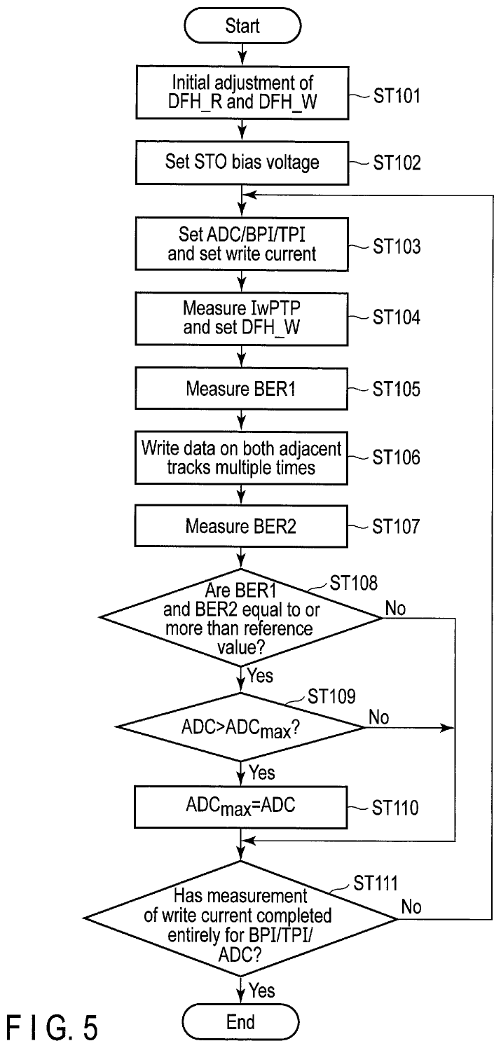

Next, the optimization method for bias voltage applied to the STO element 46 will be described. FIG. 5 is a flowchart illustrating an example of the optimization method.

Firstly, the CPU 19 performs initial adjustment of a read heater value DFH R and a write heater value DFH_W (ST101). More specifically, the read heater value DFH R and the write heater value DFH_W are adjusted and set so that each of the read head 30 and the write head 40 have a desired spacing from a surface of the magnetic disk 11 with no STO bias voltage or no recording current applied.

Next, the CPU 19 sets STO bias voltage (ST102) and then sets ADC/BPI/TPI and write current (ST103). Here, ADC/BPI/TPI settings will be described. Bits per inch (BPI) and tracks per inch (TPI) are settings of a format of the magnetic disk 11, and ADC (BPI×TPI) is a setting of recording density.

Next, the CPU 19 measures IwPTP which is a change in spacing of the write head and sets DFH_W (ST104). More specifically, after setting STO bias voltage, the CPU 19 sets the recording density, format, and recording current, measures the STO bias voltage during writing or a change in spacing of the write head 40 caused by heat generated by the recording current, and determines the write heater value (DFH_W=DFH_W−IwPTP) upon writing. After setting the conditions in this way, the CPU 19 writes/reads data and measures a bit error rate (BER) (hereinafter referred to as “BER1”) (ST105).

Next, the CPU 19 writes data on both adjacent tracks a plurality of times with a space corresponding to the set TPI (ST106) and measures BER (hereinafter referred to as “BER2”) again (ST107). Then, the CPU 19 determines whether both BER1 and BER2 are equal to or more than a predetermined reference value (ST108). If it is determined that both of BER1 and BER2 are equal to the predetermined reference value (ST108: YES), the CPU 19 determines whether ADC measured this time satisfies ADC>ADCmax (ST109). If it is determined that ADC>ADCmax (ST109: YES) is satisfied, the ADC is set as ADCmax (ST110).

If the ADC is set to ADCmax in this way or if the CPU 19 determines in step ST108 that both BER1 and BER2 have values not equal to or more than the predetermined reference value (ST108: NO) and if the CPU 19 determines in step ST109 that ADC having been measured this time does not satisfy ADC>ADCmax (ST109: NO), the CPU 19 determines whether the measurement of write current has completed entirely for BPI/TPI/ADC (ST111). If it is determined that the measurement of the write current has not been completed entirely for BPI/TPI/ADC (ST111: NO), the process returns to step ST103, and the above-described steps subsequent to step ST103 are repeated.

On the other hand, if it is determined that the measurement of the write current has been completed entirely for BPI/TPI/ADC (ST111: YES), the CPU 19 finishes the process. Thus, the same measurement is performed for all prepared formats and write current conditions, and ADCmax is calculated as a maximum recording density satisfying the predetermined reference value for both BER1 and BER2.

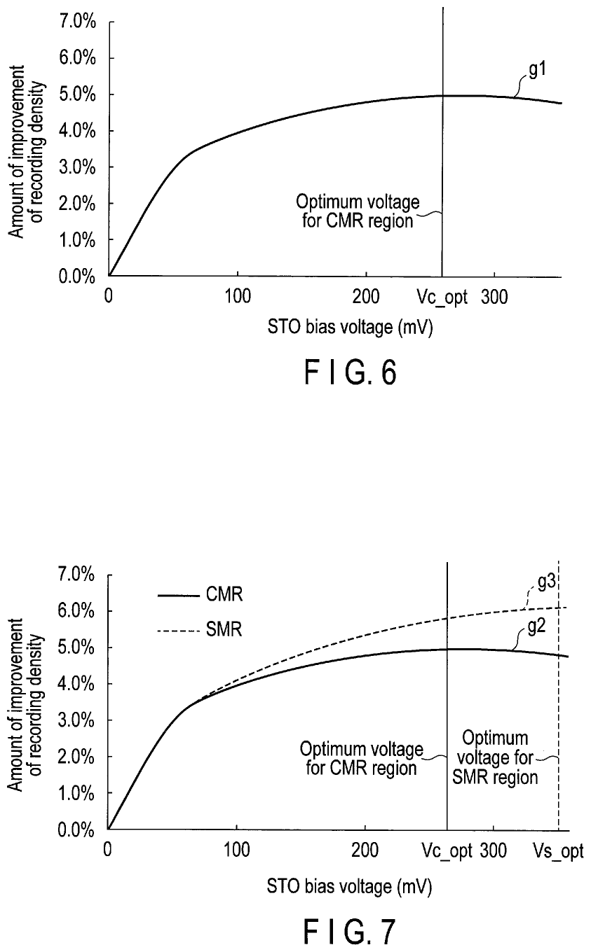

FIG. 6 is a diagram illustrating an example of an amount of improvement of the recording density in the CMR region A2 at each STO bias voltage level, showing a result of the process having been described in FIG. 5.

In FIG. 6, the horizontal axis indicates STO bias voltage (mV), and the vertical axis indicates the amount of improvement of the recording density. The upper side of the vertical axis represents higher amount of improvement of the recording density.

As a graph g1 shows, on the low voltage side (the left side in the figure), the recording density is improved as the STO bias voltage increases. On the other hand, on the high voltage side (right side in the figure), the influence of data writing on an adjacent track is large, and the recording density is saturated or reduced. In the present embodiment, in FIG. 6, the STO bias voltage at which the recording density ADCmax is maximized is Vc_opt, which is defined as a set value of the STO bias voltage in the CMR region A2.

FIG. 7 is a diagram illustrating an example of comparison in the amount of improvement of recording density at each STO bias voltage level between the CMR region A2 and the SMR region A1.

The STO bias voltage is optimized for the SMR region A1 as in the CMR region A2, but multiple writes on both adjacent tracks before measuring BER2 (step ST106 described above) is changed to one write on one track. This is because writing data by the SMR method mitigates the influence of writing data to an adjacent track. Therefore, as illustrated in graphs g2 and g3 of FIG. 7, the STO bias voltage at which the recording density is maximized is shifted to the higher voltage side (right side in the drawing) than V_copt in the CMR region. In the present embodiment, in the graph g3 in the figure, the STO bias voltage at which the recording density ADCmax is maximized is Vs_opt, which is defined as a set value of the STO bias voltage in the SMR region A1.

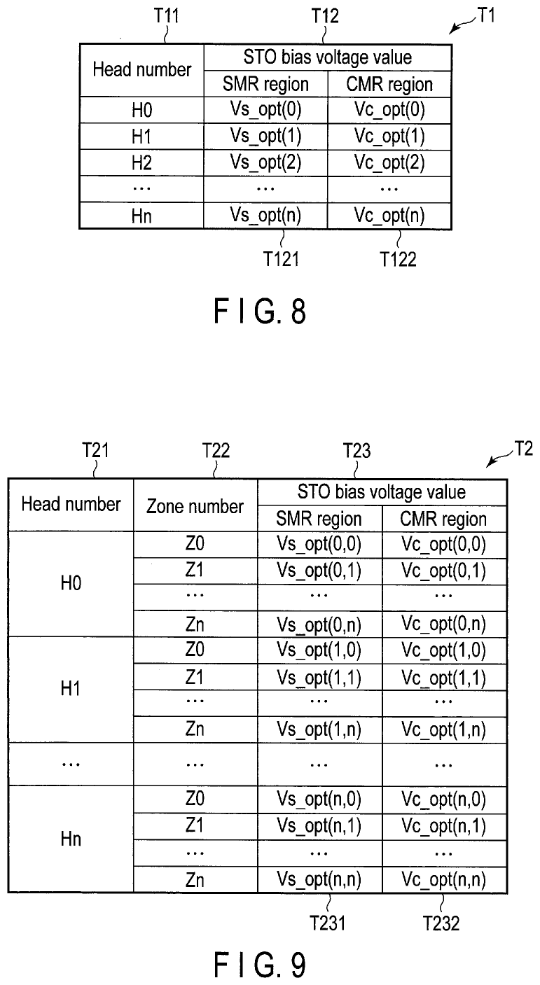

In the present embodiment, the above-described optimization of the STO bias voltage is performed for all the heads in the CMR/SMR region A2 or A1, during a manufacturing process of the magnetic disk device 100. Then, STO bias voltage values applied to the STO element 46 by the head amplifier circuit 16, upon writing are stored in the memory 20 in the form of a matrix table illustrated in FIG. 8.

FIG. 8 is a table illustrating an example of setting STO bias voltage values.

In a matrix table T1, a head number T11 and an STO bias voltage value T12 are associated with each other. The head number T11 represents the number of a magnetic head 13. In the STO bias voltage value T12, bias voltages Vs_opt and Vc_opt are set for an SMR region T121 and a CMR region T122, respectively.

In the magnetic disk device 100, when data is written on the magnetic disk 11 after shipment from a manufacturer, an STO bias voltage value is read from the memory 20 based on a head number from which writing data is performed and the SMR region or CMR region to which the data is to be written, and the read STO bias voltage value is set as an STO bias voltage value to be applied to the STO element 46 by the head amplifier circuit 16, and thus, the data is written. As described above, an optimum STO bias voltage value in writing data can be set according to the SMR region A1 or the CMR region A2, and thus, the magnetic disk device 100 having a large capacity, high reliability, and high manufacturing yield can be obtained.

Note that, in the above embodiment, the setting of the STO bias voltage values stored in the memory 20 for the respective head numbers T11, SMR regions T121, and CMR regions T122 is described as illustrated in FIG. 8, but setting of the STO bias voltage is not limited to this description. For example, a structure for managing all zones may be further added.

FIG. 9 is a table illustrating an example of setting STO bias voltage values where setting for each zone is added.

As illustrated in FIG. 9, in a matrix table T2, a head number T21, a zone number T22, and an STO bias voltage value T23 are associated with each other, and in the STO bias voltage value T23, bias voltages Vs_opt and Vc_opt are set for an SMR region T231 and a CMR region T232, respectively. As described above, since the zones for which setting is performed is added to the setting of STO bias voltage values, the magnetic disk device 100 is further allowed to set optimum STO bias voltage upon writing data according to the SMR region A1 and the CMR region A2.

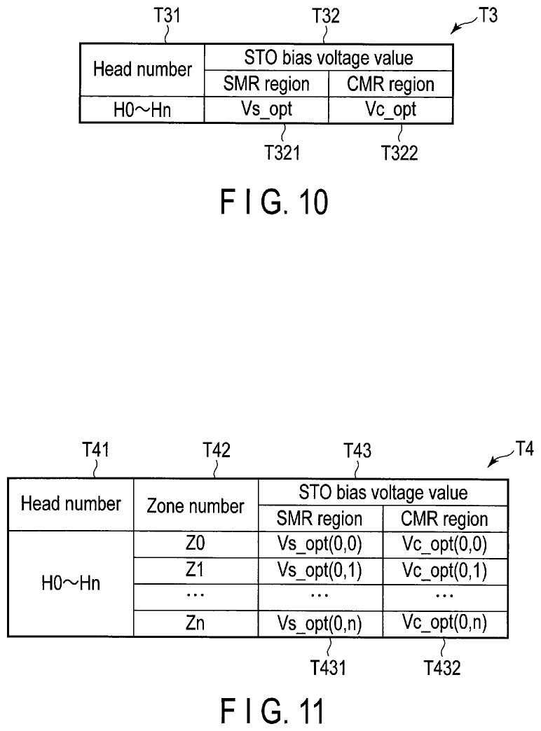

Furthermore, the STO bias voltage may be optimized not for all the magnetic heads 13 but for a predetermined number of heads, and in the manufacturing process, an average value of the STO bias voltage may be set as a fixed value for each of the heads or each of the heads/zones in the memory 20, as in matrix tables T3 and T4, which are illustrated in FIGS. 10 and 11. FIG. 10 is a table illustrating the matrix table T3 as an example of setting STO bias voltage values where a fixed value is set for all zones, and FIG. 11 is a table illustrating the matrix table T4 as an example of setting STO bias voltage values where a fixed value is set for each zone. By setting the matrix table in this way, a time period required for manufacturing the magnetic disk device 100 can be reduced. Note that the optimization method and reference value for the STO bias voltage may be changed according to a specification of the magnetic disk device 100.

### Second Embodiment

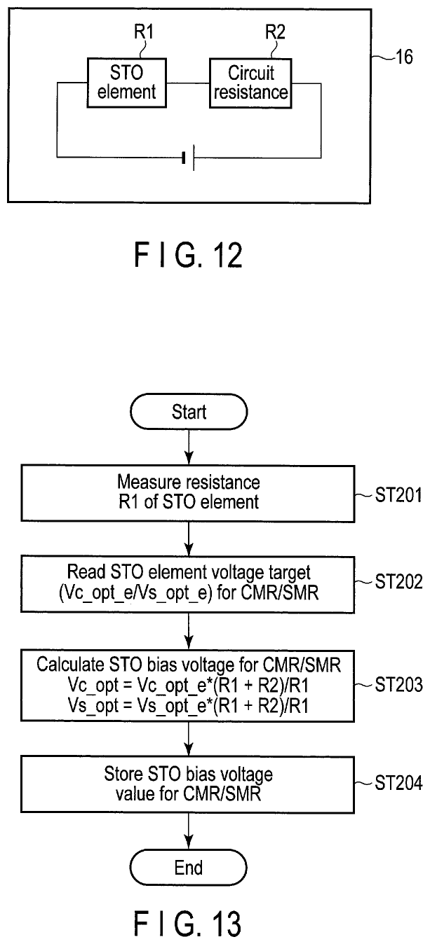

In the above embodiment, in a case where the fixed value is used as the STO bias voltage value (see FIG. 10), voltage directly applied to the STO element 46 (STO element voltage) varies due to variations in the resistance of the STO element, and variations in the amount of improvement of the recording density also increase. STO element voltage Ve is defined as Ve=V×R1/(R1+R2) by STO bias voltage V, resistance R1 of an STO element 46, and circuit resistance R2 connected in series to the STO element. Therefore, measuring the resistance R1 of the STO element enables calculation of the STO bias voltage for obtaining desired STO element voltage Ve. Note that FIG. 12 is a diagram illustrating an example of the resistance R1 of the STO element and the circuit resistance R2 in a preamplifier.

Next, processing for setting the STO bias voltage will be described. FIG. 13 is a flowchart illustrating an example of processing for setting the STO bias voltage.

As illustrated in FIG. 13, in a manufacturing process, a CPU 19 measures the resistance R1 of the STO element 46 (ST201), reads an STO element voltage target (Vc_opt_e, Vs_opt_e) indicating a desired voltage value of the STO element 46 for the CMR/SMR region A2 or A1 (ST202), and calculates an STO bias voltage (Vc_opt, Vs_opt) so as to have the STO element voltage target (ST203).

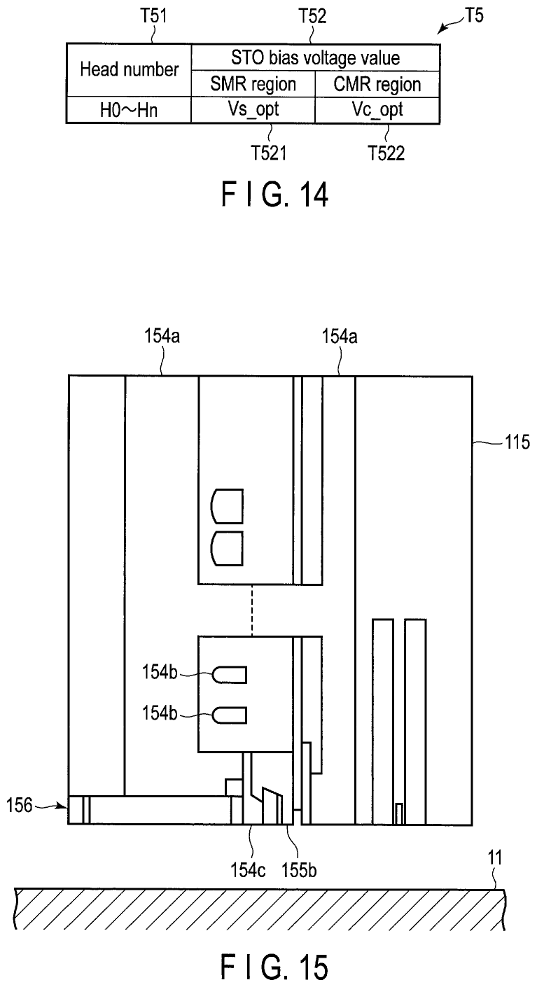

Specifically, the CPU 19 calculates the STO bias voltages Vc_opt and Vs_opt, from Vc_opt=Vc_opt_e×(R1+R2)/R1 and Vs_opt=Vs_opt_e×(R1+R2)/R1, respectively. The CPU 19 stores the STO bias voltage value for the CMR/SMR region, calculated in this way, in a memory 20 in the form of a matrix table T5 illustrated in FIG. 14 (ST204). FIG. 14 is a table illustrating the matrix table T5 as an example of setting the STO bias voltage values, and in the matrix table T5, a head number T51 and an STO bias voltage value T52 are associated with each other. The STO bias voltage value T52 includes an SMR region T521 and a CMR region T522, the SMR region T521 stores Vs_opt, and the CMR region T522 stores Vc_opt.

With this configuration, when writing data, the magnetic disk device 100 keeps the STO element voltage constant for each of the SMR region A1 and the CMR region A2 of the magnetic disk 11, reducing variations in characteristics. Note that the calculation formula for calculating the STO bias voltage value is presented as an example, and the calculation formula for the STO bias voltage differs depending on a circuit connected to the STO element 46.

### Modifications

Furthermore, in the above embodiments, the magnetic heads 13a and 13b adopting microwave assisted magnetic recording as a method of assisting in recording data have been described, but the method of assisting in recording data Is not limited thereto. For example, the techniques described in the above embodiments can be also applied to a magnetic disk device adopting heat-assisted magnetic recording as a method of assisting in recording data.

FIG. 15 is a diagram illustrating an example of a cross-section of a schematic configuration of a magnetic head adopting the heat-assisted magnetic recording. FIG. 15 illustrates the magnetic head 115 including a main magnetic pole 154c of soft magnetic material which is disposed opposite to a magnetic disk 11 including a recording layer having magnetic anisotropy in a direction substantially perpendicular to a data surface, a magnetic yoke 154a which is disposed joined to the main magnetic pole, a coil 154b which is circumferentially wound around a portion of the magnetic yoke, a light emission unit (assist unit) 155b which is disposed in a traveling direction of the magnetic head relative to the main magnetic pole to emit light to the recording layer, and a distance adjustment unit 156 configured to adjust the distance in the traveling direction of the magnetic head between the main magnetic pole and the light emission unit 155b. In the magnetic disk device including the magnetic head 115 capable of changing the intensity of light (assist power) emitted to the recording layer by the light emission unit 155b and the distance adjustment unit 156, as described above, a configuration in which the assist power is changed between the CMR region and the SMR region upon writing data can also provide the same effects as those in the above embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk;
a write head which includes an assist unit configured to assist in writing data to the magnetic disk;
a read head configured to read data from the magnetic disk; and
a control unit configured to control writing data to the magnetic disk by the write head and reading data from the magnetic disk by the read head;
wherein the magnetic disk includes a first region in which reading/writing data is performed by a first method and a second region in which reading/writing data is performed by a second method different from the first method, and
the control unit is operable to change assist power of the assist unit between the first region and the second region when writing data to the magnetic disk by the write head.

2. The magnetic disk device according to claim 1, wherein
the assist unit includes a high-frequency element, and
the control unit is operable to change the assist power by applying different bias voltages to the high-frequency element, in the first region and the second region.

3. The magnetic disk device according to claim 2, wherein
the magnetic disk device has a plurality of pairs of the write head and the read head, and
the control unit is operable to apply the bias voltage preset to each of the write heads to the high-frequency element, in addition to the first region and the second region.

4. The magnetic disk device according to claim 2, wherein
the first region and the second region each includes a plurality of zones, and
the control unit is operable to apply the bias voltage preset to each of the zones to the high-frequency element, in addition to the first region and the second region.

5. The magnetic disk device according to claim 2, wherein
the bias voltage applied to the high-frequency element in each of the first region and the second region is set such that the high-frequency element has a fixed voltage value.

6. The magnetic disk device according to claim 5, wherein
the fixed voltage value is determined based on a resistance value of the high-frequency element and a resistance value of a circuit in which the high-frequency element is incorporated.

7. The magnetic disk device according to claim 1, wherein
the first method is a conventional magnetic recording (CMR) method,
the second method is a shingled magnetic recording (SMR) method, and
the assist power of the assist unit is set higher in the SMR method than in the CMR method.

8. The magnetic disk device according to claim 1, wherein
the assist unit includes a light emission unit, and
the control unit is operable to control the light emission unit to have different outputs between the first region and the second region to change the assist power of the assist unit.
